(19) United States
(12) Patent Application Publication
(10) Pub. No.: US 2016/0081512 A1
(43) Pub. Date: Mar. 24, 2016

(54) Disposable or Reusable Beverage Filter Cartridge for Use in Beverage Brewing or Steeping Applications and Related Methods

(71) Applicant: Alan J. Bornt, Holtville, CA (US)

(72) Inventor: Alan J. Bornt, Holtville, CA (US)

(21) Appl. No.: 14/490,441

(22) Filed: Sep. 18, 2014

(51) Int. Cl. A47J 31/40; A23F 5/26; A23L 2/38; A23F 3/18; A47J 31/38; A47J 31/46

(52) U.S. Cl. CPC A47J 31/407; A47J 31/38; A47J 31/46; A23L 2/38; A23F 3/18; A23F 5/262

(57) ABSTRACT

Disclosed may be a disposable or reusable beverage filter cartridge for use in (a) pressurized flow or drip beverage brewing machines or (b) beverage steeping applications. In a preferred embodiment, the cartridge is defined by a tubiform frame and a filter pocket extending from one end of the tubular frame.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

The subject matter of this application is in the field of disposable or re-usable beverage filter cartridges for use in (a) pressurized flow or drip beverage brewing machines or (b) beverage steeping applications.

2. Background.

Brewed or steeped beverages are popular drinks throughout the United States and around the world. Coffee and tea are just two examples of brewed or steeped beverages that are consumed in large quantities on a daily basis. Many different types of brewing or steeping machines or applications are known and have proven useful for preparing brewed or steeped beverages.

Recently, “single-serve” (typically around twelve ounces or less) brew beverage machines have become common. These single serve machines generally operate by flowing water (e.g., by pressure or gravity) through a preloaded, single-use, and sealed beverage filter cartridge with enough brew-material (e.g., coffee grinds, tea blends, powdered drink mixes, or anything else that releases flavor or nutrition when contacted by a fluid) for a single serving of the brewed beverage. These machines are convenient, fast, and conservative because the beverage is brewed and filtered in as much time as the water can flow through the beverage filter cartridge and only a single serving is prepared.

Despite their benefits, current single serve machines are not satisfactory for every situation. One problem is that the amount of brew-material in a sealed single-use beverage filter cartridge cannot be customized to a particular person's tastes or a particular situation. Also, a universal filter cartridge for every beverage brewing machine or steeping method does not exist.

In view of the foregoing, two solutions have been proposed for machine-brewing or steeping single-serving drinks: open beverage filter cartridges; and reusable beverage filter cartridges. While open beverage filter cartridges enable customization of the amount of brew-material used to make a single serving drink, open filter cartridges are messy and cannot be easily used in pressurized flow beverage brewing or steeping methods. Reusable filter cartridges can be sealed and enable customized brewing of single serving drinks, but are difficult to clean after use and are limited to single servings of twelve ounces or less. Neither open nor reusable filter cartridges have been made universal to all brewing machines or steeping applications. Thus, a need exists for a universal beverage filter cartridge that eliminates or reduces the problems associated with known beverage filter cartridges.

### SUMMARY OF THE INVENTION

Disclosed may be a disposable or reusable beverage filter cartridge for use in (a) pressurized flow or drip beverage brewing machines or (b) beverage steeping applications. In a preferred embodiment, the cartridge is defined by a tubular frame and a filter pocket extending from one end of the tubular frame. In one mode of operation, the filter pocket may be filled with an amount of brew-material and draped over the rim of a beverage container so that the brew-material inside of the pocket may be submerged in the container's contents for steeping. In another mode of operation, the beverage container pocket may be filled with brew-material that is bound entirely within the tubular frame so that a fluid may be passed through the tubular frame (e.g., by pressure or gravity) to brew a beverage. In either embodiment, the filter pocket may be cleaned by turning the pocket inside out and running water or other cleaning fluid through the filter pocket. Finally, the filter frame may be configured for use in any beverage brewing methods.

Other objectives and desires may become apparent to one of skill in the art after reading the below disclosure and viewing the associated figures. Also, these and other embodiments will become apparent from the drawings.

### BRIEF DESCRIPTION OF THE FIGURES

The manner in which these objectives and other desirable characteristics can be obtained is explained in the following description and attached figures in which:

FIG. 1 is a perspective view of a beverage filter cartridge defined by a frame and a filter pocket;

FIG. 2 is a perspective view of the beverage filter cartridge of FIG. 1 with the filter pocket turned inside out and provided through the frame;

FIG. 3 is a schematic that illustrates the construction and manipulation of the cartridge of FIGS. 1 and 2;

FIG. 4 is a schematic that illustrates a steeping application of the cartridge of FIG. 1;

FIG. 5 is a schematic that illustrates a brewing application of the cartridge of FIG. 2;

FIG. 6 is a schematic that illustrates a brewing application of the cartridge of FIG. 5;

FIG. 7 is an exploded cross-section view of a pressurized beverage brewing system;

FIG. 8 is a cross-section view of the pressurized beverage brewing system of FIG. 7;

FIG. 9 is an exploded cross-section view of a pressurized or drip beverage brewing system; and

FIG. 10 is a cross-section view of the pressurized or drip beverage brewing system of FIG. 9; and

FIG. 11 is a cross-section view of an alternate embodiment of a bottle for a pressurized or drip beverage brewing system.

It is to be noted, however, that the appended figures illustrate only typical embodiments of the disclosed assemblies, and therefore, are not to be considered limiting of their scope, for the disclosed assemblies may admit to other equally effective embodiments that will be appreciated by those reasonably skilled in the relevant arts. Also, figures are not necessarily made to scale.

### DETAILED DESCRIPTION OF PREFERRED EMBODIMENTS

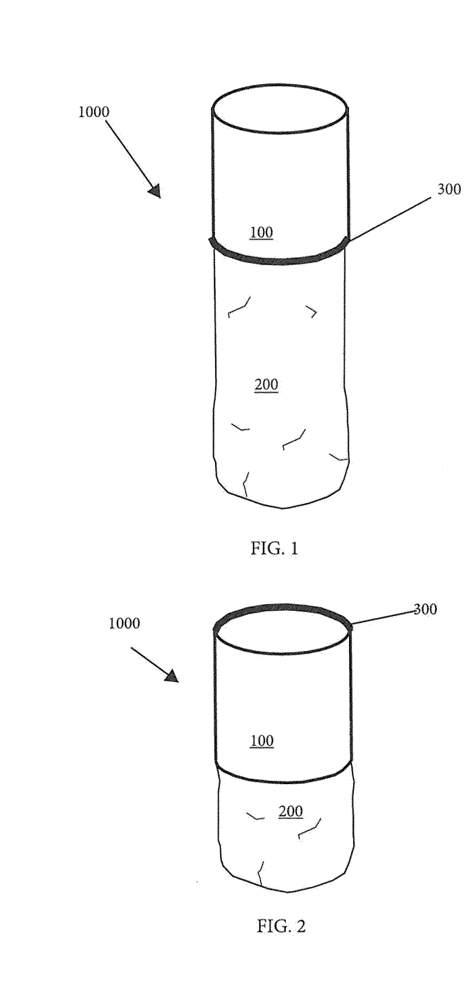

FIG. 1 is a perspective view of a beverage filter cartridge 1000 defined by a frame 100 and a filter pocket 200. FIG. 2 is a perspective view of the beverage filter cartridge 1000 of FIG. 1. In the depicted embodiment, the pocket 200 is suitably adhered around one end of the tubular frame 100 via an adhesive 300. These figures illustrate that the cartridge 1000 has two basic configurations: (A) the frame 100 with the pocket 200 dangling from one end so that its entire length is exposed (FIG. 1); and (B) the frame 100 with the pocket 200 dangling therethrough so that only a portion of the pocket 200 is exposed out of the frame 100 (FIG. 2). As discussed in greater detail below, the configuration of the cartridge 1000 shown in FIG. 2 can be achieved by turning the filter pocket 200 inside out relative to its configuration of FIG. 1 while, at the same time, providing the pocket 200 through the frame 100.

Referring to FIG. 1, the frame 100 is suitably a rigid tubiform. In a preferred embodiment the frame 100 is constructed of a paper or plastic tubiform. Those of skill in the art will know any other materials, like metals, composites, or woods, capable of being used for constructing the frame 100 after reading this disclosure. Although shown as a cylindrical tubiform or tube, other tubiform shapes can be used for constructing the frame without departing from the spirit and intent of this disclosure.

Still referring to FIG. 1, the filter 200 may be constructed of any filter material suitable for filtering beverages. In one embodiment, the filter is constructed of paper with filaments that are approximately twenty micrometers wide whereby particles of less than approximately ten to fifteen micrometers may pass threrethrough. Other papers, fabrics, or metallic meshes with similar qualities may further be employed for constructing the filter pocket 200. Those of skill in the art will know the materials that are useful for constructing the filter pocket 200 of the present invention. In a preferred embodiment, the pocket 200 is two times longer than the length of the frame 100.

Finally, FIG. 1 depicts the frame 100 and filter pocket 200 being connected via an adhesive 300. Suitably, any non-toxic adhesive 300 that is capable of binding plastic or paper tubes 100 to paper, fabric or metal filter pockets 200 will be suitable for constructing the cartridge 1000 shown in FIG. 1.

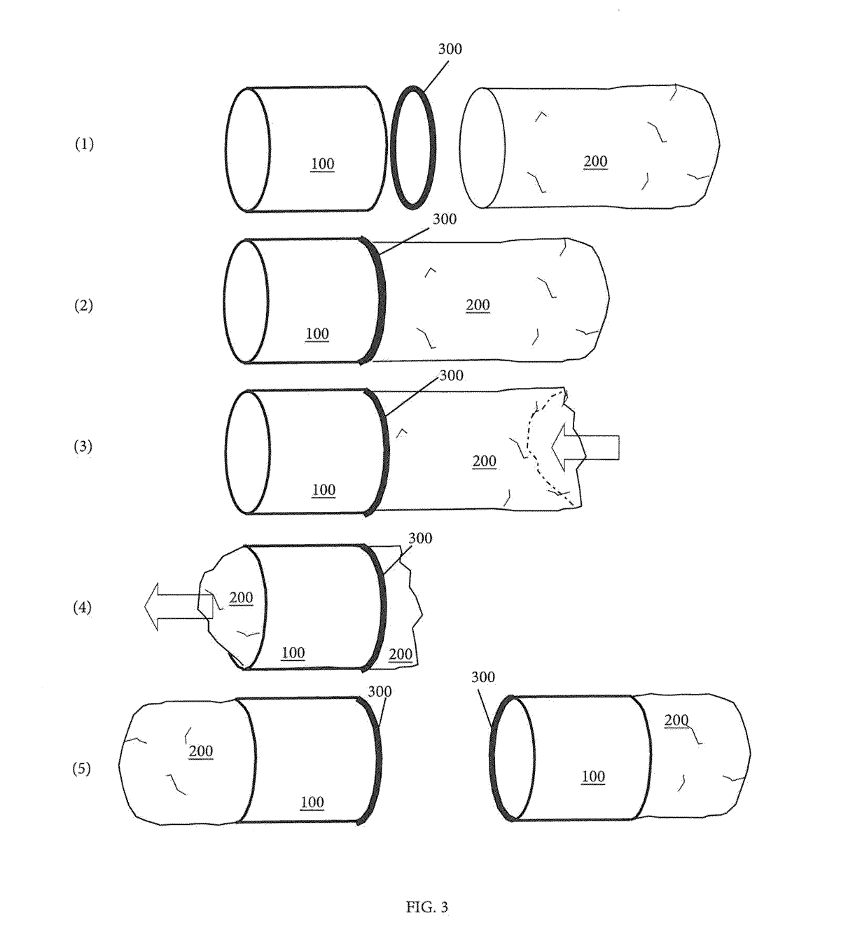

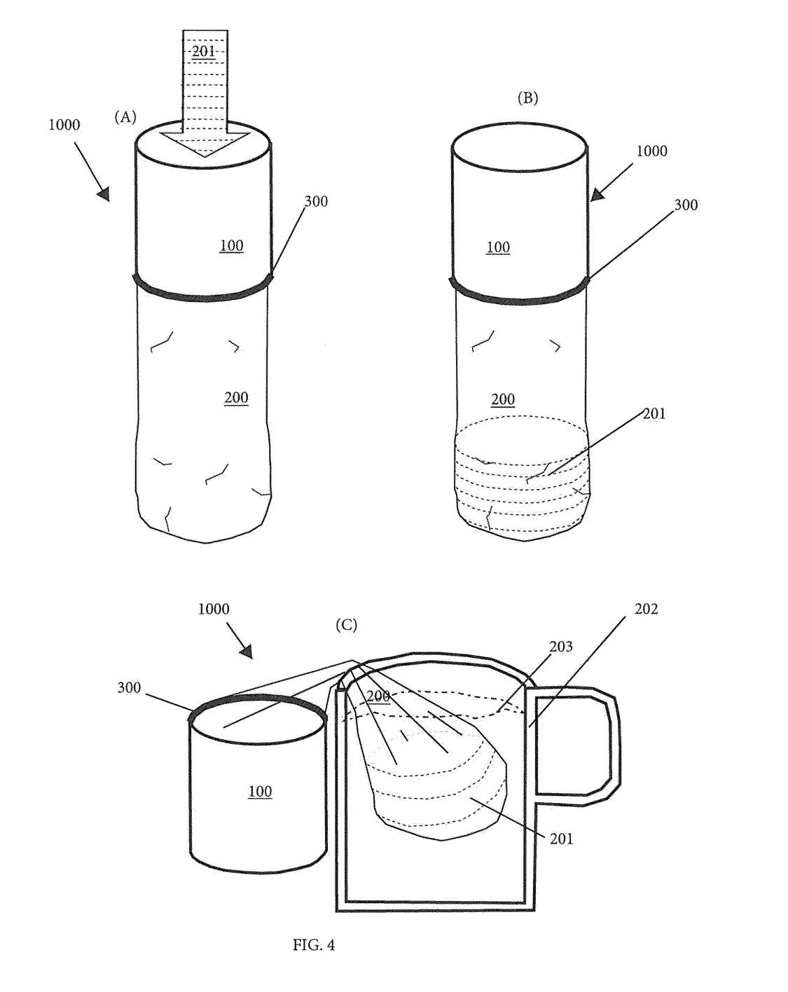

FIG. 3 is a schematic that illustrates the construction and manipulation of the cartridge 1000 of FIGS. 1 and 2. As shown, the figure illustrates five ((1) through (5)) stages of construction and manipulation of the cartridge 1000. Stage (1) illustrates the construction of the cartridge 1000. As shown, the opening of the pocket 200 is adhered around one end of the frame 1000 via an adhesive. Stages (2) through (5) illustrate the manipulation of the cartridge 1000 between its two basic configurations shown earlier in FIGS. 1 and 2. The first basic configuration is shown in stage (2) of FIG. 3. This basic configuration is defined by the pocket dangling from the adhesive 300 end of the frame 100. Stages (3) and (4) illustrate the process of turning the pocket 200 inside-out by pushing the bottom of the pocket through the frame 100. Stage (5) shows the second basic stage of FIG. 2, which is defined by the frame 100 with the pocket 200 dangling therethrough so that only a portion of the pocket 200 is exposed out of the frame 100.

FIG. 4 is a schematic that illustrates a steeping application of the cartridge 1000 of the first basic configuration (see, e.g., FIG. 1). First (A), a cartridge 1000 may be positioned with the pocket dangling from the frame 1000. Next (B), a brew-material 201, e.g., coffee grinds or tea blends, may be deposited through the frame 100 into the filter pocket 200. Finally, the filter pocket 200 may be draped over the rim of a beverage container 202 (shown in cross-section) so that the brew-material 201 within the pocket 200 hangs into the container 202. In this application, the frame 100 suitably provides a counterbalance outside of the beverage container 202. Preferably, a fluid 203 may be provided to the container 202 so that the brew-material 201 within the pocket 200 is submerged by the fluid 203 and steeping occurs. In a preferred embodiment, the brew-material 201 is coffee or tea and the fluid 203 is water or milk. Suitably, the filter pocket 200 may be cleaned after use by turning the pocket 200 inside-out and running water or other cleaning fluid through the filter pocket (the process for turning the pocket 200 inside-out is illustrated in FIG. 3). For embodiments employing a paper frame 100, the cartridge 100 may be discarded after use.

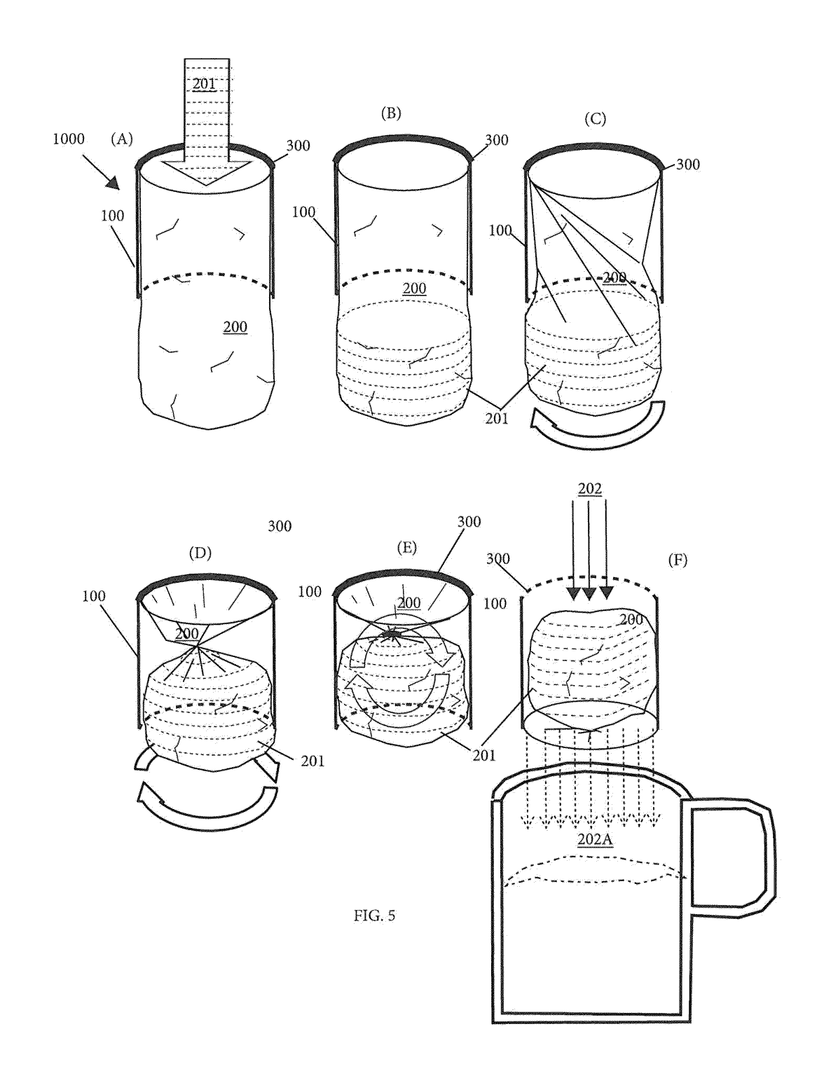

FIG. 5 is a schematic that illustrates a brewing application of the second basic cartridge configuration 1000 illustrated earlier in FIG. 2. First (A), a cartridge 1000 may be positioned with the pocket dangling through the frame 1000 (shown in cross section in this figure). Next (B), a brew-material 201, e.g., coffee grinds or tea blends, may be deposited through the frame 100 into the filter pocket 200. Suitably, the deposited brew-material 201 may be wound-up in the pocket 200. This winding-up is shown in steps (C) through (E). As shown, the pocket 200 (shown in (C)) may be turned in either direction to bind the brew-material 201 to within the pocket 200 (shown in (D)). Once bound, the bound brew-material 201 may be wound-up via continued turning of the pocket until the entire contents 201 of the pocket 200 are disposed within the frame 200 (see step (E)). Finally (F), brewing fluid 202 may be provided/directed through the frame 200 to contact with the brew-material 201 via pressure or gravity so that a brewed beverage 202A exits the frame 200. Although the brewing fluid may be provided through the frame 200 in either direction, suitably, the brew fluid 202 is provided to the frame 200 so that the flow does not unwind the filter as shown. Suitably, the filter pocket 200 may be cleaned after use by turning the pocket 200 inside-out and running water or other cleaning fluid through the filter pocket 200 (the process for turning the pocket 200 inside-out is illustrated in FIG. 3). For embodiments employing a paper frame 100, the cartridge 100 may be discarded after use.

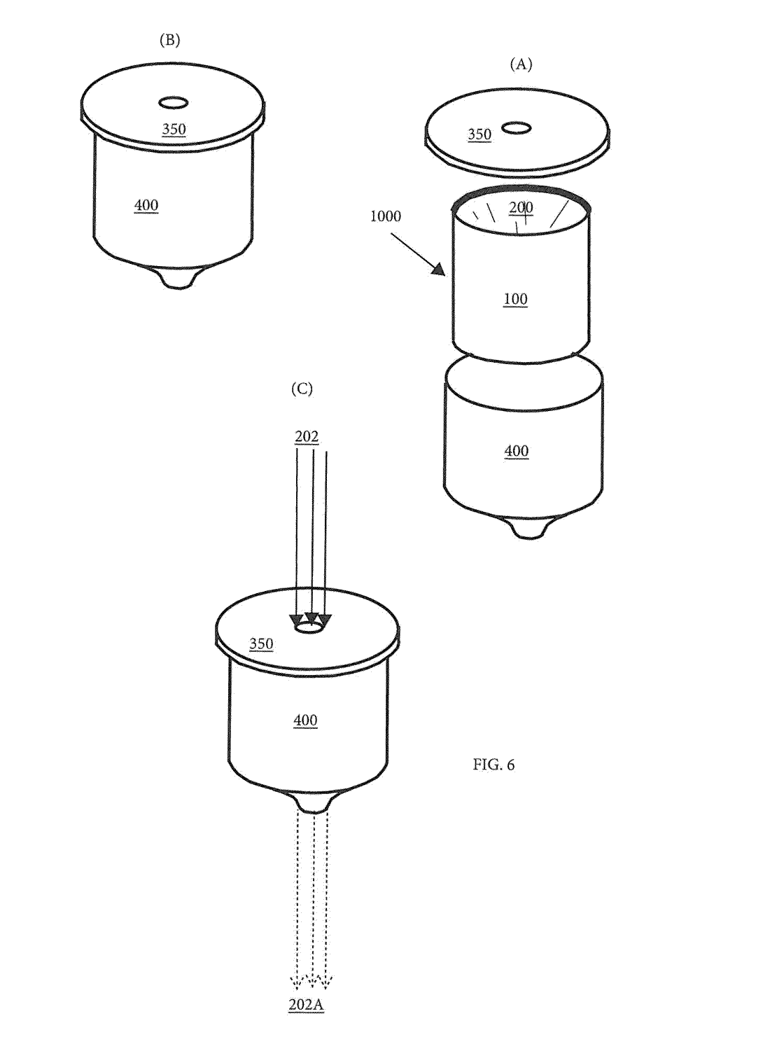

As discussed above, the beverage filter cartridge 1000 may be universally applied to beverage brewing machines. Typically, beverage brewing machines feature filter cartridge repositories. Other beverage brewing machines feature reusable filter cartridge adaptors for placement into the repositories (see e.g., 2013/0199379). In either case, the disclosed beverage filter cartridge 1000 is capable of being used in these machines. FIG. 6 is a schematic that illustrates a brewing application wherein the disclosed beverage cartridge 1000 is used with such machines. As shown (A), a loaded beverage filter cartridge 1000 may be provided to within an adaptor/receptacle 400 of a brewing machine. In a preferred embodiment, a lid 350 may be set or positioned over the frame 200 of the cartridge 1000 in a fluid tight arrangement (see step (B)). In one embodiment, the lid 350 may feature a rubber gasket or ring to provide the preferred fluid tightness when the same is placed under pressure over the frame 100. In another embodiment, the lid 350 may be constructed of silicon or other material that will deform for fluid tightness under pressure over the frame 100. Finally (C), fluid 202 may be provided through the lid 350 and out of the adaptor/receptacle 400 as a brewed beverage 202A.

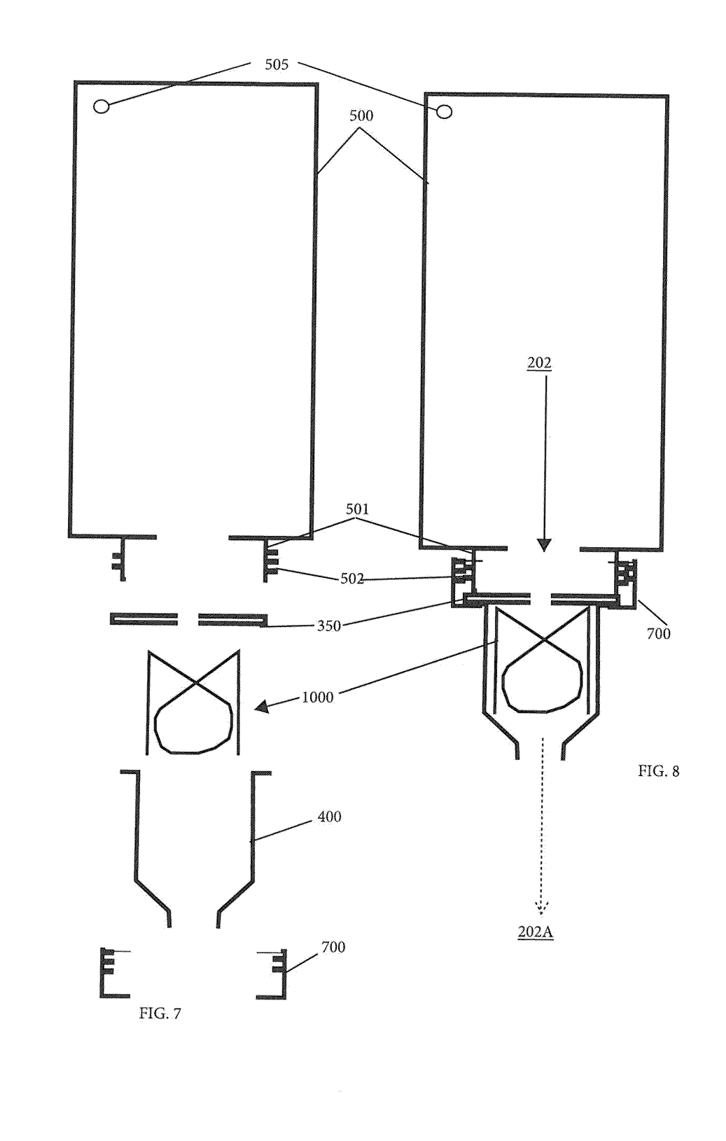

FIG. 7 is an exploded cross-section view of a pressurized beverage brewing system. FIG. 8 is a cross-section view of the pressurized beverage brewing system of FIG. 7. As shown in these figures, the disclosed beverage filter cartridge may be used in connection with an adaptor 400, a lid 350, a squeeze bottle 500, and a cap 700 to construct the depicted pressurized beverage brewing system. Suitably, the lid 350, cartridge 1000 and adaptor 400 may be assembled as described above in connection with FIG. 6. The adaptor 400 assembly may be provided to the mouth 501 of the squeeze bottle and secured there via a cap 700 with an opening to allow the distal end of the adaptor 400 to protrude. Suitably, the cap 700 is configured with teeth to cooperate with the threads 502 around the mouth 501 of the squeeze bottle 500. Suitably, the cap 700 should be screwed over the mouth 501 of the squeeze bottle with enough pressure to cause the o-ring, gasket, or silicon of the lid 400 to become fluid tight with the cartridge 1000. In operation, the squeeze bottle 500 may be filled with a brew-fluid 202 and manipulated to force the fluid 202 through the cartridge 1000 to create a brewed beverage 202A. Suitably, the squeeze bottle 500 features a vent or valve 505 to facilitate the squeezing of water through the cartridge 1000. In a preferred embodiment, “cold brew” brew-material may be used in connection with the squeeze bottle 500. That said, “hot brew” brew material may be used in connection with the squeeze bottle 500 if the squeeze bottle 500 is constructed of material that will neither be damaged by near-boiling water temperatures nor transfer harmful heat to a user of the system. For instance, the squeeze bottle 500 can be made of durable heat resistant plastic or a plastic silicone mix to deal with hot contents.

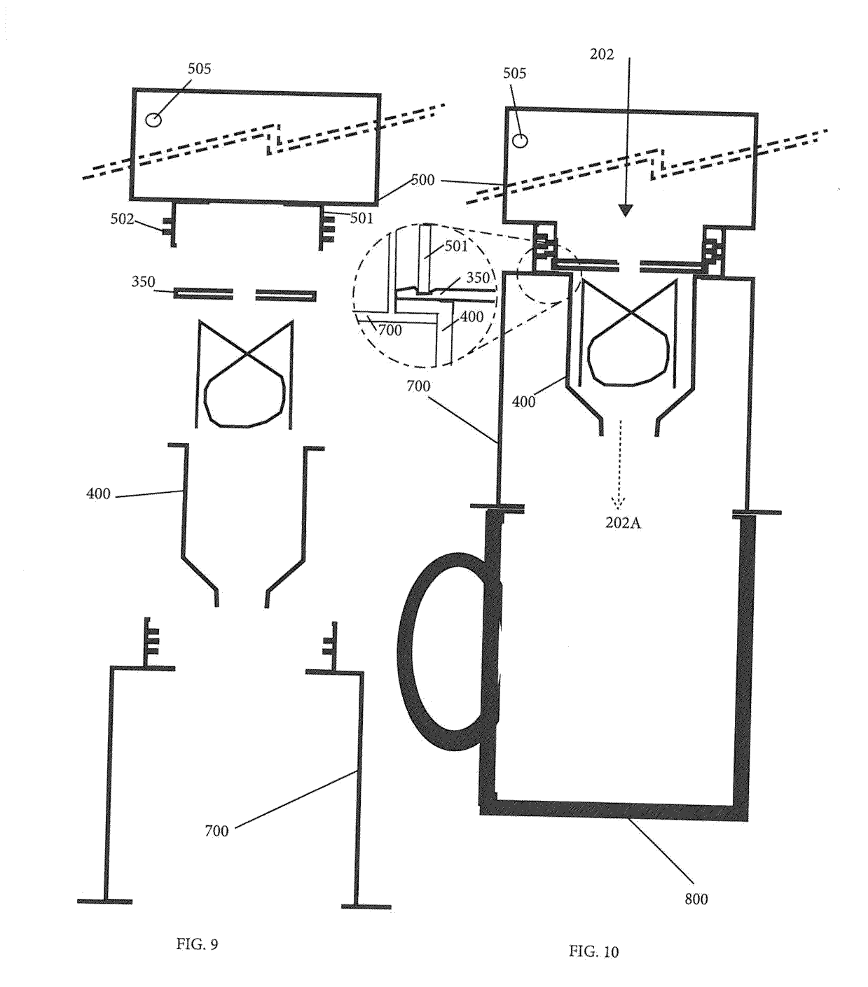

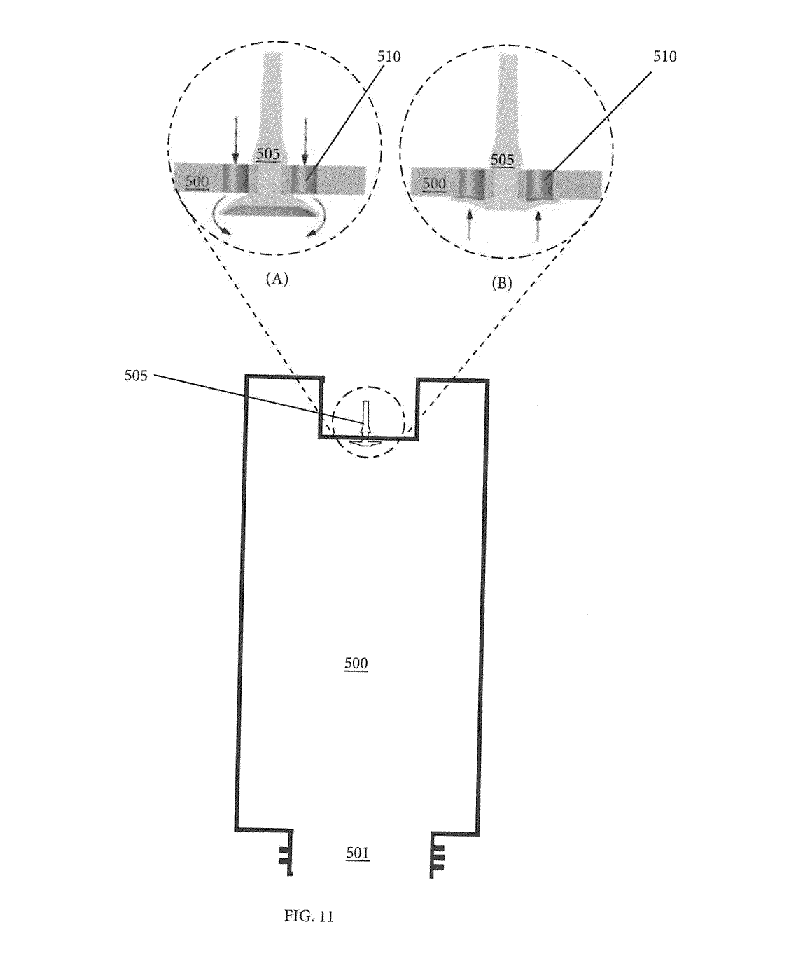

FIG. 9 is an exploded cross-section view of a pressurized or drip beverage brewing system. FIG. 10 is a cross-section view of the pressurized or drip beverage brewing system of FIG. 9. As shown, the system is similar to the system of FIGS. 7 and 8. The difference is that the system shown in FIG. 9 features a platform 700 that may be used to position the system over a beverage container 800. Referring to FIG. 10, the lid 350 and adapter 400 are suitably sandwiched between the mouth 501 of the bottle 500 and the platform 700 whereby the lid 350 is deformed to create a tight seal. This seal is suitably shown in the blow-out view of FIG. 10. In a preferred embodiment, the system is configured to brew ice coffee 202A via drip from the squeeze bottle 500. For a squeeze bottle 500 that is capable of retaining hot fluids without melting, hot beverages may be brewed using the system as described above in connection with FIGS. 7 and 8. It should be noted that container 800 is not a required component of the brewing system.

FIG. 11 is an alternate embodiment of a bottle 500 that might be used in the above described system. As shown, the bottle 500 features a rubber or silicone umbrella vent 505 at an upper portion thereof. Suitably, the umbrella vent 505 enables the operation of the bottle in both drip and pressurized beverage systems. FIG. 11 shows two blow-out views of the vent 505, i.e., (A) and (B). As shown in blow-out (A), the umbrella valve is defined by a deflectable gasket that is configured to selectively open or close two holes 510 in the bottle. Suitably, the umbrella valve 505 will open (see (A)) in response to negative pressure within the bottle 500 so that brew material (not shown) may drip or slowly flow from the mouth 501 of the bottle 500. Preferably, the umbrella valve 505 will close (B) in response to positive pressure in the bottle so that brew material may be forced or pressured to flow from the mouth 501 of the bottle 500. Thus, the bottle 500 may be used for either drip or pressurized brewing systems.

Still referring to FIG. 11, a negative pressure within the bottle can be achieved by squeezing the bottle and releasing the squeeze pressure while a brew fluid is positioned within the bottle. Once squeeze pressure is released, the negative pressure within the bottle will open the umbrella valve so that drip or low flow brewing may be accomplished. Positive pressure within the bottle 500 may be achieved by applying squeeze pressure to the bottle 500. Thus, squeezing the bottle 500 may be the preferred method of accomplishing pressurized brewing.

Other features will be understood with reference to the drawings. While various embodiments of the method and apparatus have been described above, it should be understood that they have been presented by way of example only, and not of limitation. Likewise, the various diagrams might depict an example of an architectural or other configuration for the disclosed method and apparatus, which is done to aid in understanding the features and functionality that might be included in the method and apparatus. The disclosed method and apparatus is not restricted to the illustrated example architectures or configurations, but the desired features might be implemented using a variety of alternative architectures and configurations. Indeed, it will be apparent to one of skill in the art how alternative functional, logical or physical partitioning and configurations might be implemented to implement the desired features of the disclosed method and apparatus. Also, a multitude of different constituent module names other than those depicted herein might be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claim submitted with this specification are incorporated by reference in their entirety as if fully set forth herein.

I claim:

1. a beverage filter cartridge comprising:
a tubiform frame;
a filter pocket that is adhered around an end of the tubiform frame.

2. The cartridge of claim 1 wherein the frame is paper.

3. The cartridge of claim 1 wherein the frame is plastic.

4. A method of preparing a beverage comprising the steps of:
placing a brew material into a filter pocket that is coupled to an end of a tubiform frame; and,
contacting the brew material in the filter pocket to a fluid.

5. The method of claim 4 wherein contact of the brew material and fluid is accomplished by passing the fluid through the tubiform frame.

6. The method of claim 4 wherein contact of the brew material and fluid is accomplished by hanging the pocket over a rim of a beverage container containing the fluid.

7. The method of claim 4 further comprising the steps of winding up the brew material in the pocket so that the pocket and brew material are disposed within the frame.

8. The method of claim 7 wherein the frame is plastic and further comprising the step of turning the pocket inside out and contacting the pocket with fluid for cleaning.

9. The method of claim 7 wherein the frame is paper and further comprising the step of discarding the cartridge.

10. A beverage preparation system comprising:
a cartridge defined by a tubiform frame and a filter pocket;
an adaptor configured to receive and retain the cartridge;
a lid configured to provide a fluid tight seal over an end of the frame of the cartridge; and,
a fluid source for passing fluid through the lid, into the cartridge, and out of the adaptor.

11. The system of claim 10 wherein the water source is a squeeze bottle.

12. The system of claim 11 further comprising a beverage filter platform.

13. The system of claim 10 wherein the water source is a brewing machine.

14. The system of claim 11 wherein the squeeze bottle features a valve that is opened for drip brewing or steeping preparation or closed for pressurized brewing or steeping preparations.
